(19) United States
(12) Patent Application Publication
(10) Pub. No.: US 2008/0163447 A1
(43) Pub. Date: Jul. 10, 2008

(54) Multi-bladed wiper apparatus

(76) Inventor: Allan D. Smith, Clinton, UT (US)

Correspondence Address: JAMES RAY & ASSOCIATES, 2640 PITCAIRN ROAD, MONROEVILLE, PA, 15146, US

(21) Appl. No.: 12/006,635

(22) Filed: Jan. 4, 2008

Related U.S. Application Data
(60) Provisional application No. 60/878,532, filed on Jan. 4, 2007.

(51) Int. Cl. B60S 1/28

(52) U.S. Cl. 15/250.41

(57) ABSTRACT

A multi-bladed wiper blade for automobile windshield wipers includes a pair of elongated wiper members and an axially elongated support member operably connected at a first side thereof to a first respective wiper member at a predetermined location thereon and at a second radially opposed side thereof to a second respective wiper member at a predetermined location thereon. An elongated covering mechanism is releasably and interchangeably connected to the support member such that at least one of such pair of wiper members is covered when an opposed one of such pair of wiper members is in use. A securing mechanism is operably connected to such support member for releasably securing the support member to such windshield wiper assembly of an automobile.

### CROSS REFERENCE TO RELATED APPLICATION

This patent application is related to and claims priority from U.S. Provisional Patent Application Ser. No. 60/878,532 filed Jan. 4, 2007.

### FIELD OF THE INVENTION

The present invention relates, in general, to automotive accessories and, more particularly, this invention relates to windshield wipers.

### BACKGROUND OF THE INVENTION

Prior to the conception and development of the present invention, windshield wipers as are generally well known in the prior art, have been used as a means to remove precipitation and debris from automobile windshields.

Specifically of interest to the present invention are the following: Yasumoto, U.S. Pat. No. 3,892,006, provides a multi-bladed wiper that rotates as it passes over a windshield.

Journee, U.S. Pat. No. 3,961,395 provides a windscreen-wiper blade having a double edged squeegee, one edge being designed to be effective in winter use and the other, in summer conditions.

Brack, U.S. Pat. No. 4,296,522 discloses a reversible dual windshield wiper having a blade holder with a flexible wiping blade mounted on each side thereof. One or more retaining clips are mounted to a wiper arm to accept and hold the blade holder with either wiping blade in the active position. Stops are also provided to prevent the wiper from moving longitudinally with respect to the arm.

Jonasson, et al, U.S. Pat. No. 5,732,437 provides a wiper blade apparatus including an elongated blade element subject to tensile force.

Nelson, U.S. Pat. No. 6,233,779, provides a multiple-bladed windshield wiper in which a blade multiple edged is axially rotated in a support bracket to bring a fresh blade edge into use.

### SUMMARY OF THE INVENTION

The present invention provides a multi-bladed wiper apparatus for automobile windshield wipers. Such multi-bladed wiper apparatus includes a pair of elongated wiper members having a first predetermined size and a first predetermined shape and being manufactured from a first predetermined material. An axially elongated support member is operably connected at a first side thereof to a first respective wiper member at a predetermined location thereon and at a second radially opposed side thereof to a second respective wiper member at a predetermined location thereon. The support member has a second predetermined size and a second predetermined shape. An elongated covering means is releasably and interchangeably connected to the support member such that at least one of such pair of wiper members is covered when an opposed one of such pair of wiper members is in use. The elongated covering means has a third predetermined size and a third predetermined shape. A securing means is operably connected to the support member for releasably securing the support member to such windshield wiper assembly of an automobile.

### OBJECTS OF THE INVENTION

It is, therefore, one of the primary objects of the present invention to provide a multiple-bladed windshield wiper that can be easily rotated to reveal a fresh wiper blade to take the place of a blade that has become old or worn.

Another object of the present invention is to provide a multiple bladed windshield wiper that can store one blade while a second blade is in use, the blade being stored is at least one of straightened, cleaned, and protected from light, elements, and debris by a cover thereby permitting it to be used at least once more prior to being discarded.

Still another object of the present invention is to provide a wiper blade that can be rotated to reveal a new wiping surface easily and quickly.

Yet another object of the present invention is to provide a two-sided wiper blade which will reduce the cost of upkeep regarding windshield wipers.

An additional object of the present invention is to provide wiper blades which feature personalization, logos, and advertising.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of a multi-bladed wiper apparatus according to one embodiment of the invention.

FIG. 2 is a partial perspective view of a multi-bladed wiper apparatus according to one embodiment of the invention showing one of the wiper blades enclosed in an elongated covering means.

FIG. 3 is a cross sectional view of a multi-bladed wiper apparatus according to one embodiment of the invention in which the support member is secured to a wiper assembly shaft inserted through an aperture disposed on the support member.

FIG. 4 is a partial perspective view of a multi-bladed wiper apparatus in which the elongated covering means includes a winged member.

FIG. 5 is a partial perspective view of a shaft style wiper assembly to which various embodiments of the invention can be attached.

FIG. 6 is a partial perspective view of a J style wiper assembly to which various embodiments of the invention can be attached.

FIG. 7 is a partial perspective view of an adapter means for a J style wiper assembly to convert it to a shaft style wiper assembly according to one embodiment of the invention.

FIG. 8 is a partial perspective view of an adapter means for a J style wiper assembly to convert it to a shaft style wiper assembly according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

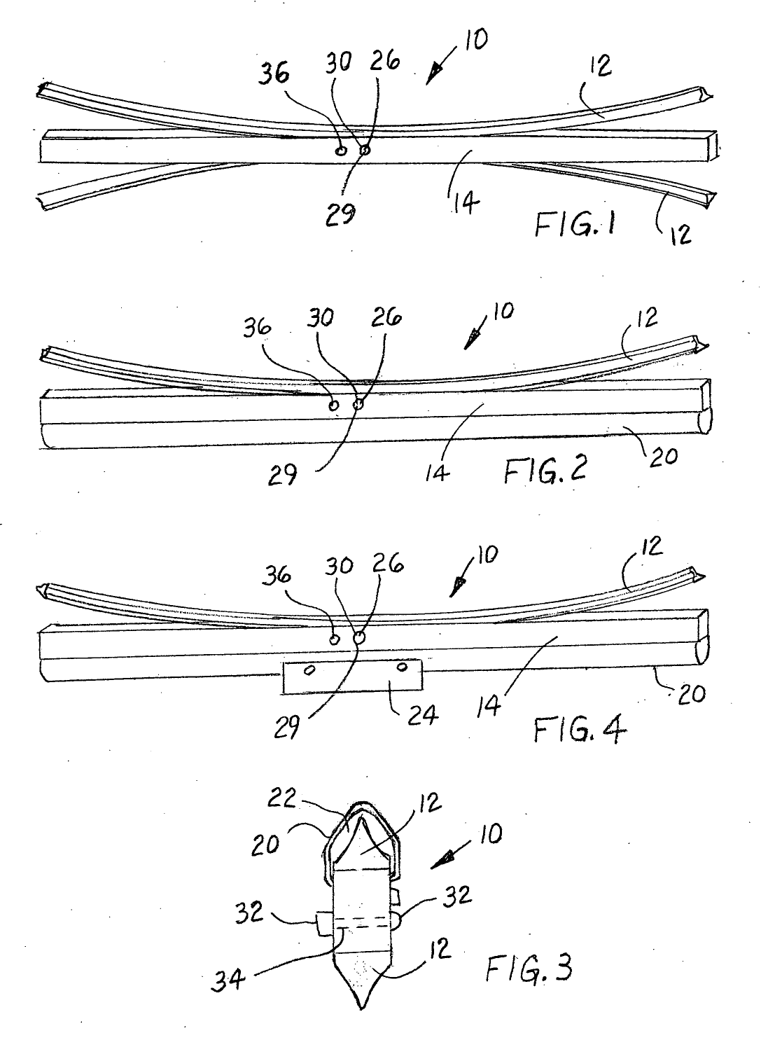

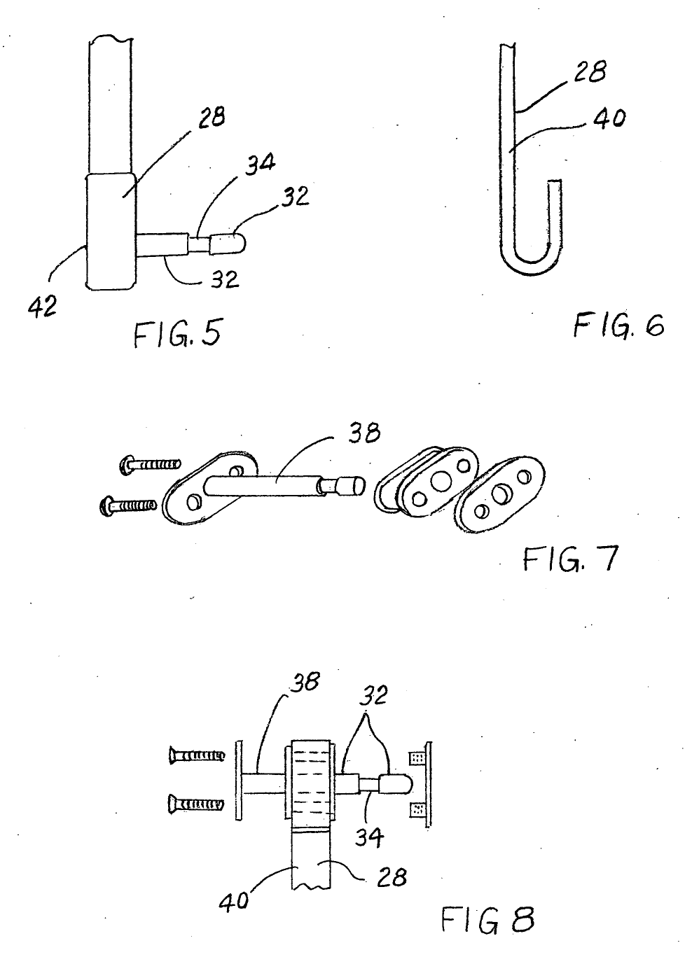

Reference is now made, more particularly, to FIGS. 1-8.

A multi-bladed wiper apparatus, generally designated 10, includes a pair of elongated wiper members 12 having a first predetermined size and a first predetermined shape and being manufactured from a first predetermined material. It is presently preferred that such first predetermined material is rubber. It is further presently preferred that such wiper members 12 are between about 18 and 21 inches long.

An axially elongated support member 14 is operably connected at a first side thereof to a first respective wiper member 12 at a predetermined location thereon and at a second radially opposed side thereof to a second respective wiper member 12 at a predetermined location thereon. The support member 14 has a second predetermined size and a second predetermined shape.

An elongated covering means 20 is releasably and interchangeably connected to the support member 14 such that at least one of such pair of wiper members 12 is covered when an opposed one of such pair of wiper members 12 is in use.

The elongated covering means 20 has a third predetermined size and a third predetermined shape. It is presently preferred that such elongated covering means 20 at least one of cleans, straightens, and shields the wiper member 12 covered by the covering means 20 from at least one of light, elements and debris, when such opposed wiper member 12 is in use.

It is also presently preferred that such elongated covering means 20 includes a lining 22 operably connected to an inside of the covering means 20 such that the lining 22 fits securely around the wiper member 12 when the wiper member 12 is covered by the elongated covering means 20.

It is further presently preferred that the elongated covering means 20 includes a winged member 24 operably and releasably connected thereto and that such winged member 24 includes at least one of a logo, personalization, symbols, figures, lettering, and pictures (not shown). The winged member 24 has a curvature such that it acts to keep the wiper member 12 in use on the windshield when in use at high rates of speed. It is presently preferred that such winged member 24 is between about 4 and 6 inches long. It is further presently preferred that such winged member is between about 1½ and 3 inches wide.

A securing means 26 is operably connected to the support member 14 for releasably securing the support member 14 to such windshield wiper assembly, generally designated 28, of an automobile (not shown). It is presently preferred that the securing means 26 further includes a rotation means 29 for rotating the support member 14 at least 180 degrees.

It is presently preferred that such securing means 26 is an aperture 30 disposed on the support member 14 at a predetermined location thereon such that a wiper assembly shaft 32, operably connected to such windshield wiper assembly 28 and having a reduced diameter portion 34 disposed at a predetermined location thereon intermediate each end thereof, is inserted through such aperture 30 such that the aperture 30 encircles the reduced diameter portion 34 of the wiper assembly shaft 32 to secure the support member 14 to such windshield wiper assembly 28 of an automobile.

It is further presently preferred that such support member 14 further includes a means 36 for varying a diameter of the aperture 30 such that the support member 14 can be at least one of rotated around the wiper assembly shaft 32 and removed from the windshield wiper assembly 28.

It is presently preferred that such multi-bladed wiper apparatus 10 is produced in a variety of colors and sizes.

According to another embodiment of the invention, it is presently preferred that the securing means 26 includes an adapter means 38 releasably and operably connected at a first predetermined location thereon to such windshield wiper assembly 28 for converting a J style wiper assembly 40 into a shaft style wiper assembly 42.

It is presently preferred that such adapter means 38 includes a wiper assembly shaft 32 operably connected at a first predetermined location thereon, such wiper assembly shaft 32 having a reduced diameter portion 34 disposed at a second predetermined location thereon intermediate each end thereof, and wherein the securing means 26 includes sliding the wiper assembly shaft 32 through an aperture 30 disposed on the support member 14 at a predetermined location thereon such that the aperture 30 encircles the reduced diameter portion 34 of the wiper assembly shaft 32. It is further preferred that such support member 14 further includes a means 36 for varying a diameter of such aperture 30 such that the support member 14 can be at least one of rotated around the wiper assembly shaft 32 and removed from the windshield wiper assembly 28.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A multi-bladed wiper apparatus for automobile windshield wipers comprising:
a. a pair of elongated wiper members having a first predetermined size and a first predetermined shape and being manufactured from a first predetermined material;
b. an axially elongated support member operably connected at a first side thereof to a first respective wiper member at a predetermined location thereon and at a second radially opposed side thereof to a second respective wiper member at a predetermined location thereon, said support member having a second predetermined size and a second predetermined shape;
c. an elongated covering means releasably and interchangeably connected to said support member such that at least one of said pair of wiper members is covered when an opposed one of said pair of wiper members is in use, said elongated covering means having a third predetermined size and a third predetermined shape; and
d. a securing means operably connected to said support member for releasably securing said support member to such windshield wiper assembly of an automobile.

2. A multi-bladed wiper apparatus for automobile windshield wipers according to claim 1 wherein said securing means further includes a rotation means for rotating said support member at least 180 degrees.

3. A multi-bladed wiper apparatus for automobile windshield wipers according to claim 2 wherein said securing means is an aperture disposed on said support member at a predetermined location thereon such that a wiper assembly shaft, operably connected to such windshield wiper assembly and having a reduced diameter portion disposed at a predetermined location thereon intermediate each end thereof, is inserted through said aperture such that said aperture encircles such reduced diameter portion of such wiper assembly shaft to secure said support member to such windshield wiper assembly of an automobile.

4. A multi-bladed wiper apparatus for automobile windshield wipers according to claim 3 wherein said support member further includes a means for varying a diameter of said aperture such that said support member can be at least one of rotated around said wiper assembly shaft and removed from such windshield wiper assembly.

5. A multi-bladed wiper apparatus for automobile windshield wipers according to claim 2 wherein said securing means includes an adapter means releasably and operably connected at a first predetermined location thereon to such windshield wiper assembly for converting a J style wiper assembly into a shaft style wiper assembly.

6. A multi-bladed wiper apparatus for automobile windshield wipers according to claim 5 wherein said adapter means includes a wiper assembly shaft operably connected at a first predetermined location thereon, said wiper assembly shaft having a reduced diameter portion disposed at a second predetermined location thereon intermediate each end thereof, and wherein said securing means includes sliding said wiper assembly shaft through an aperture disposed on said support member at a predetermined location thereon such that said aperture encircles said reduced diameter portion of said wiper assembly shaft.

7. A multi-bladed wiper apparatus for automobile windshield wipers according to claim 6 wherein said support member further includes a means for varying a diameter of said aperture such that said support member can be at least one of rotated around said wiper assembly shaft and removed from said windshield wiper assembly.

8. A multi-bladed wiper apparatus for automobile windshield wipers according to claim 2 wherein said first predetermined material is rubber.

9. A multi-bladed wiper apparatus for automobile windshield wipers according to claim 2 wherein said elongated covering means includes a winged member operably and releasably connected thereto.

10. A multi-bladed wiper apparatus for automobile windshield wipers according to claim 9 wherein said winged member includes at least one of a logo, personalization, symbols, figures, lettering, and pictures.

11. A multi-bladed wiper apparatus for automobile windshield wipers according to claim 2 wherein said multi-bladed wiper apparatus is produced in a variety of colors and sizes.

12. A multi-bladed wiper apparatus for automobile windshield wipers according to claim 2 wherein said elongated covering means is capable of at least one of cleaning said wiper member covered by said covering means when said opposed wiper member is in use, straightening said wiper member covered by said covering means when said opposed wiper member is in use, and shielding said wiper member covered by said covering means from light when said opposed wiper member is in use.

13. A multi-bladed wiper apparatus for automobile windshield wipers according to claim 12 wherein said elongated covering means includes a lining operably connected to an inside of said covering means such that said lining fits securely around said wiper member when said wiper member is covered by said elongated covering means.

14. A multi-bladed wiper apparatus for automobile windshield wipers according to claim 2 wherein said wiper members are between about 18 and 21 inches long.

15. A multi-bladed wiper apparatus for automobile windshield wipers according to claim 9 wherein said winged member is between about 4 and 6 inches long.

16. A multi-bladed wiper apparatus for automobile windshield wipers according to claim 15 wherein said winged member is between about 1½ and 3 inches wide.
